(19) United States
(12) Patent Application Publication
(10) Pub. No.: US 2013/0290138 A1
(43) Pub. Date: Oct. 31, 2013

(54) Search Method, Apparatus and Server for Online Trading Platform

(71) Applicant: Xiao Wen Pan, Hangzhou (CN)

(72) Inventor: Xiao Wen Pan, Hangzhou (CN)

(73) Assignee: ALIBABA GROUP HOLDING LIMITED, Grand Cayman (KY)

(21) Appl. No.: 13/389,996

(22) PCT Filed: Oct. 24, 2011
(86) PCT No.: PCT/US11/57524

§ 371 Date: Feb. 10, 2012

(30) Foreign Application Priority Data
Nov. 1, 2010 (CN) 201010529419.8

(51) Int. Cl. G06Q 30/06

(52) U.S. Cl. CPC G06Q 30/0623
USPC 705/26.61

(57) ABSTRACT

A search method includes, based on a query term presently submitted from a browser, obtaining initial web pages that match the query term from a predetermined database. The predetermined database is configured to store web pages, at least one product identifier referenced in a respective web page, and relationships between the product identifiers and the respective web pages. The method also includes performing relevancy processing for the initial web pages to obtain relevant web pages that satisfy a predetermined criterion, performing relevancy processing for at least one product corresponding to product identifier(s) referenced in the relevant web pages, and displaying the at least one product that has undergone the relevancy processing to a client according to respective relevancy scores.

### CROSS REFERENCE TO RELATED PATENT APPLICATIONS

This application is a national stage application of an international patent application PCT/US11/57524, filed Oct. 24, 2011, which claims priority to Chinese Patent Application No. 201010529419.8, filed on Nov. 1, 2010, entitled “Search Method, Apparatus and Server for Online Trading Platform,” which applications are hereby incorporated by reference in their entirety.

### TECHNICAL FIELD

The present disclosure relates to the field of network data processing, and more particularly, search methods, apparatuses and servers for online trading platforms.

### BACKGROUND

In response to receiving a query term inputted from a user, a search on an online trading platform normally displays a number of products that include the query term to the user. These products that include the query term are products that may be of interest to the user. Generally, by relating these products with keywords, a product related to a keyword may be obtained when the keyword related thereto is inputted.

When a user searches for a specific product, existing technologies generally adopt an approach as follows: performing keyword matching based on a name, a category and/or an attribute of a product. This type of search approach is, however, only applicable for such keywords as simple product category terms or product names and product attributes. If a query term that is inputted by the user does not include a specific name or attribute of a product, a result may not be found even though that type of products exists. An example is a keyword of “mobile phone suitable for women”. Since data stored in a database is normally built up based on keywords such as product names, categories and attributes without storing keyword information that is merely descriptive, a result that is desired by the user may not be found. For example, “Phillips 588” is generally considered as a mobile phone that is suitable for women. However, the user cannot find this mobile phone when searching using the terms “mobile phone suitable for women” on the online trading platform.

From the above analysis of the existing technologies, as the existing technologies cannot completely match the needs of users when realizing searches on online trading platforms, the users are required to change query terms to continue the searches if no results that are of interest to the users are returned. This increases the number of interactions between the users and an associated server. On the server end, the process of matching the query terms and hence the workload of the server are increased, thus further affecting the operation speed and performance of the server of the online trading platform.

In short, an urgent technical problem that needs to be addressed by one skilled in the art is: how to innovatively develop a search method for an online trading platform in order to solve the technical problem in existing technologies that the failure of finding results desired by the users affects operation speed and performance of a server of the online trading platform.

### SUMMARY

A technical problem to be addressed by the present disclosure is to provide a search method for an online trading platform in order to solve the technical problem in existing technologies that the failure of finding results desired by the users affects the operation speed and performance of a server of the online trading platform.

The present disclosure further provides a search apparatus and server for an online trading platform to ensure the implementation and application of the aforementioned method in practice.

In order to solve the aforementioned problem, the present disclosure discloses a method of setting up a web page database. In one embodiment, the method fetches a web page. Upon fetching the web page, the method may analyze keywords of the web page to obtain product keyword(s) referenced in the web page. In some embodiments, the method may further analyze the product keyword(s) based on predetermined rule(s) to obtain at least one product identifier related to the web page. In one embodiment, the method may further store the web page, the at least one product identifier and a relationship between the web page and the product identifier in a predetermined database.

In one embodiment, the present disclosure further discloses a search method for an online trading platform. In one embodiment, based on a query term presently submitted from a browser, the search method may obtain initial web pages that match the query term from a predetermined database. The predetermined database may be configured to store web pages, at least one product identifier referenced in a respective web page, and relationships between the product identifiers and the respective web pages. In response to obtaining the initial web pages, the search method may further perform relevancy processing for the initial web pages to obtain relevant web pages that satisfy a predetermined criterion. Additionally, the search method may perform relevancy processing for at least one product corresponding to product identifier(s) referenced in the relevant web pages. In response to performing the relevancy processing for the at least one product, the search method may display the at least one product that has undergone the relevancy processing to a client according to respective relevancy scores.

In some embodiments, the present disclosure further discloses a search apparatus for an online trading platform. The search apparatus may include an initial web page search module. Based on a query term, the initial web page search module obtains initial web pages that match the query term from a predetermined database. The predetermined database is configured to store web pages, at least one product identifier included in the web pages, and relationships between the web pages and respective product identifiers.

The search apparatus may further include a relevant web page acquisition module which is configured to perform relevancy processing for the initial web pages to obtain relevant web pages that satisfy predetermined criterion. Additionally, the search apparatus may include a product relevancy processing module. In one embodiment, the product relevancy processing module may be configured to perform relevancy processing for at least one product corresponding to product identifier(s) referenced in the relevant web pages. In some embodiments, the search apparatus may further include a display ordering module that is configured to display the at least one product that has undergone the relevancy processing to a client according to respective relevancy scores.

Compared to the existing technologies, the present disclosure may include the following example advantages.

In the present disclosure, product information that appears in a web page is associated with the web page in advance. Therefore, web information of a product will be considered when a search that is based on a keyword inputted by a user on an online trading platform is performed. Specifically, as long as a forum or a web page mentions a certain product, related products can be found during a product search based on this relationship between the product and the web page. This avoids a scenario in which a search fails to return a product if a query term inputted by a user does not include a specific name or attribute of the product while web page information of the product includes information related to the query term, thereby improving user search efficiency. Through the present disclosure, a user does not need to repeatedly search for related products, thus reducing the number of interactions between the user and a search engine server. This reduces the number of redundant operations in the search engine server, and therefore improves operation speed, work efficiency and work performance of the search engine server. Understandably, any product implementing the present disclosure does not need to achieve all of the above advantages at one time.

### DESCRIPTION OF DRAWINGS

In order to more clearly understand the technical scheme of the exemplary embodiments of the present disclosure, accompanying figures that are needed for the description of the exemplary embodiments are briefly introduced below. Understandably, the following figures only constitute a few exemplary embodiments of the present disclosure. Based on these accompanying figures, one of ordinary skills in the art can obtain other figures without making any creative effort.

FIG. 1 shows a flow chart of setting up a predetermined database in accordance with the first exemplary embodiment of the present disclosure.

FIG. 2 shows a flow chart of a search method for an online trading platform in accordance with the first exemplary embodiment of the present disclosure.

FIG. 3 shows a flow chart of a search method for an online trading platform in accordance with a second exemplary embodiment of the present disclosure.

FIG. 4 shows a schematic diagram of displaying a search result in accordance with the second exemplary embodiment of the present disclosure.

FIG. 5 show a structural diagram of a search apparatus for an online trading platform in accordance with a third exemplary embodiment of the present disclosure.

FIG. 6 shows a structural diagram of a search apparatus for an online trading platform in accordance with a fourth exemplary embodiment of the present disclosure.

FIG. 7 shows the exemplary search apparatus described in FIGS. 5 and 6 in more detail.

### DETAILED DESCRIPTION

The technical scheme in the exemplary embodiments of the present disclosure will be described clearly and completely below using the accompanying figures in the exemplary embodiments. Understandably, the exemplary embodiments described herein only constitute parts, but not all, of exemplary embodiments of the present disclosure. Based on the exemplary embodiments of the present disclosure, one skilled in the art can obtain all other exemplary embodiments, which are still within the scope of the present disclosure.

The disclosed method and system may be used in an environment or in a configuration of universal or specialized computer system(s). Examples include a personal computer, a server computer, a handheld device or a portable device, a tablet device, a multi-processor system, and a distributed computing environment including any system or device above.

The disclosed method and system can be described in the general context of computer-executable instructions, e.g., program modules. Generally, the program modules can include routines, programs, objects, components, data structures, and the like that perform particular functions or implement particular abstract data types. The disclosed method and system can also be practiced in a distributed computing environment where functions are performed by remote processing devices that are linked through a communication network. In a distributed computing environment, the program modules may be located in local and/or remote computer storage media, including memory storage devices.

In the exemplary embodiments of the present disclosure, web pages that are fetched by a web crawler are pre-processed. For example, for a fetched web page, a certain number of specific products that are primarily referenced in the content of the web page are recognized. Product identifiers of these products may then be related to or associated with the web page. These relationships as well as the web page and the product identifiers that are included in the relationships may be stored into a web page database that has been set up in advance for future invocation of the relationships by the web page database. The aforementioned process of pre-processing may be carried out offline. Specifically, the same process of pre-processing may be performed as long as a web page is fetched by the crawler in order to build up the web page database. In response to receiving a query term submitted from a browser, a search engine server may find initial web pages that match the query term from the pre-set database based on the query term. The search engine server may perform relevancy processing for the found initial web pages to obtain relevant web pages that satisfy a predetermined criterion, and perform relevancy processing for at least one product corresponding to product identifier(s) that is/are referenced in the relevant web pages. Furthermore, the search engine server may order the at least one product that the relevancy processing has been performed according to respective relevancy score(s), and display multiple ordered products to a client, e.g., displaying information such as prices or sales volumes of the products.

As can be seen, a product that is eventually obtained from a search using the embodiments of this disclosure not only relates to a query term inputted by a user, but also relates to whether the product is referenced in a certain web page. The techniques described herein can avoid a scenario in which a user inputs a descriptive query term and no relevant result can be found based directly on the query term. For instance, for a query term of “mobile phones suitable for women”, if content discussing “mobile phones suitable for women” appears in a certain forum or web page and if a number of mobile phones that are suitable for women including “Philips 588” are referenced in the content, the database will store a relationship between the web page and “Philips 588”. When the search engine server searches for mobile phones that are suitable for women in the future, a web page related to product sales of “Phillips 588” will come up. The user may not need to repeatedly search for related products if this product information is displayed. Therefore, this reduces the number of interactions between the user and the search engine server, reduces the number of redundant operations in the search engine server, and increases operation speed, work efficiency and work performance of the search engine server.

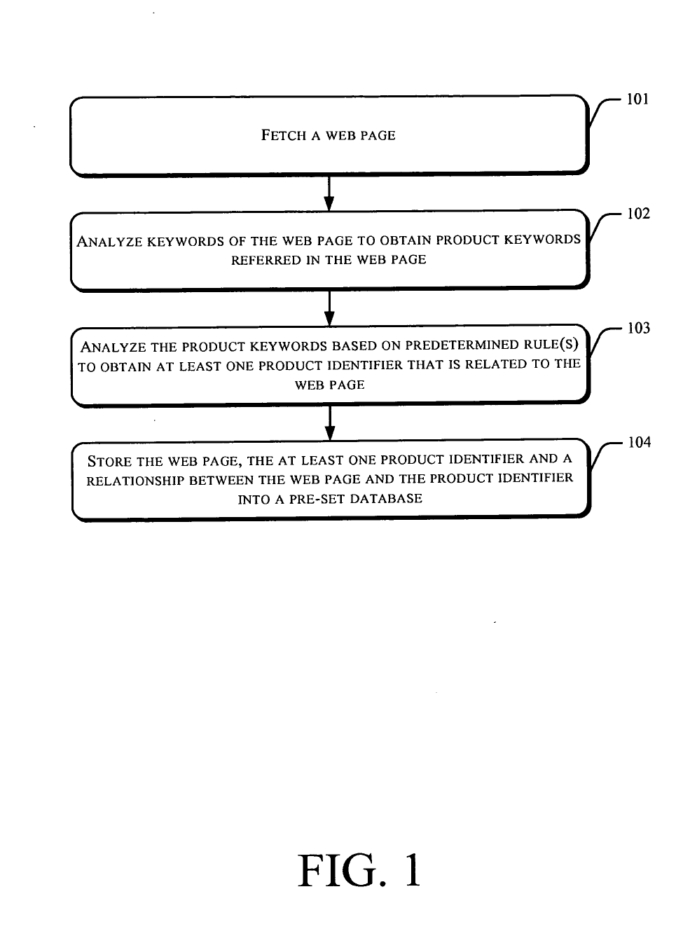

FIG. 1 illustrates a flowchart of an exemplary method of setting up a web page database.

At 101, the method fetches a web page.

The web page herein refers to a web page fetched by a crawler server. The crawler server does not require a triggering condition, and once started, will continue to fetch web pages.

At 102, the method analyzes keywords of the web page to obtain product keywords referenced in the web page.

When the crawler fetches a web page from the Internet, the fetched web page is analyzed. Specifically, the content in the web page is extracted to discover product keywords appearing in the web page content. For example, if a post discussing “mobile phones suitable for women” appears in a certain forum, this current block will obtain the mobile phones that are suitable for women from a result of user discussion.

In a practical application, details of block 102 may be implemented through the following approach.

First, textual content of the web page is extracted.

The web page fetched by the crawler server may not only include textual information, but also other information such as an image or video advertisement, etc. Therefore, the current block extracts textual content of the web page first, e.g., information about a discussion of a certain product in a forum.

Second, the textual content is analyzed to obtain relevant keywords of the web page.

A word parser may be used to parse the textual content. Various keywords obtained by the word parser are rendered as relevant keywords of the web page. Understandably, this block may use other tools to parse the textual content of the web page, and the parsing method does not affect the implementations of the present disclosure.

Third product keywords that are related to products are obtained from the relevant keywords.

All the relevant keywords obtained from the textual content are analyzed to find product keywords that are related to products. For example, if relevant keywords obtained at block A2 include “of”, “thus”, “Nokia 5530”, “Lenovo Group”, etc., this current block may obtain “Nokia 5530” and “Lenovo Group” as the product keywords.

At 103, the method analyzes the product keywords based on predetermined rule(s) to obtain at least one product identifier that is related to the web page.

Specifically, in a practical application, block 103 may use the following approach to obtain at least one product identifier that is related to the web page.

First, candidate keywords which probabilities of occurrence are greater than a given threshold are determined or obtained from the product keywords.

At this stage, multiple product keywords may appear in a web page. For example, product keywords such as “Nokia 5530”, “Lenovo Group” and “Samsung” may appear at the same time with respective probabilities of occurrence being 10, 5 and 1. If a predetermined threshold is 2, this block will select “Nokia 5530” and “Lenovo Group” as candidate keywords.

Second, whether the candidate keywords are related to the textual content of the web page is determined.

At this stage, if the current web page is a post discussing the performance of mobile phones, the candidate keywords obtained at block B1 are those product identifiers related to the web page because the two candidate keywords “Nokia 5530” and “Lenovo Group” are both related to the mobile phones. However, if a candidate keyword of “Proctor & Gamble”, which is clearly unrelated to the performance of mobile phones, appears, “Proctor & Gamble” will not be rendered as a product identifier related to the web page.

At 104, the method stores the web page, the at least one product identifier and a relationship between the web page and the product identifier into a pre-set database. Upon searching the database based on a query term and finding a web page matching the query term, a product identifier is outputted based on a relationship between the matched web page and the product identifier.

At this stage, based on the obtained product, a corresponding product identifier is related to the web page in which the product appears. The relationship herein can be understood as a certain relationship followed by the web page and corresponding product identifier. The product identifier may be obtained upon obtaining the web page.

If multiple products appear in a web page, weights may be set up when relating the products and the web page based on information such as respective numbers of occurrence and respective positions of occurrence of the products in the web page. For instance, if a certain product has the highest number of occurrence in a web page or appears in a relative important plate of a template of the web page, a higher weight may be set up for the relationship between the product identifier of that product and the web page. Therefore, a web page may be related to multiple products, and these multiple products may be ordered according to respective weighted relationships.

Upon relating the web page to the product, the relationship between the web page and at least one product identifier may be stored in the database. When storing, related content of the web page and the product information may further be stored in the database to facilitate retrieval of the web page content and the product information such as price and sales volumes in future invocation.

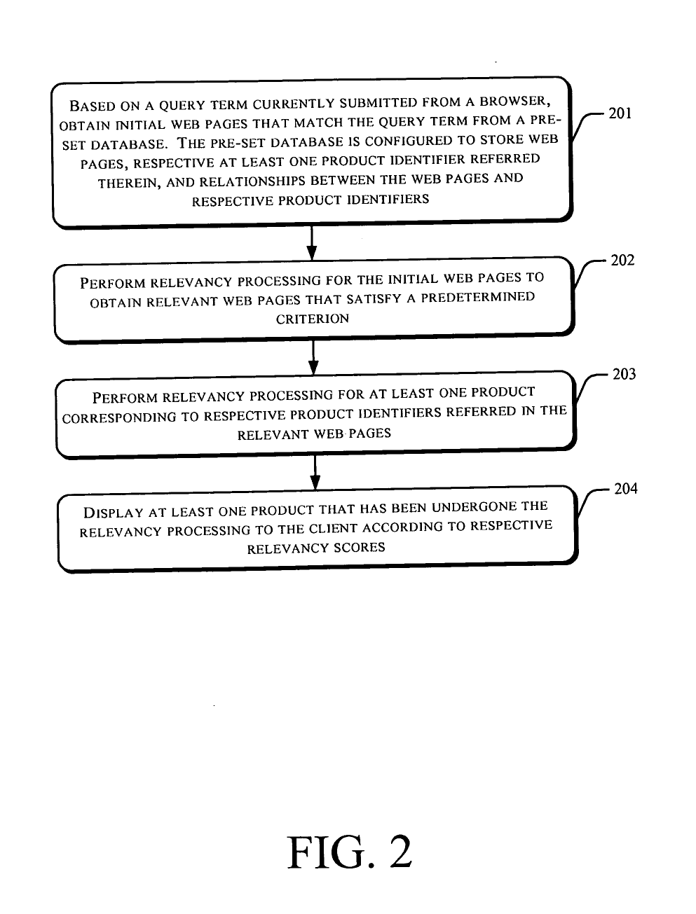

FIG. 2 shows a flowchart of an exemplary search method for an online trading platform in accordance with the first exemplary embodiment of the present disclosure.

At 201, based on a query term currently submitted from a browser, the method obtains initial web pages that match the query term from a pre-set database. The pre-set database is configured to store web pages, respective at least one product identifier referenced therein, and relationships between the web pages and respective product identifiers.

In this exemplary embodiment, after a user inputs a query term in an input box that is provided by an online trading platform, an associated browser submits the query term to a backend search engine system. The search engine system finds initial web pages that match the query term from a pre-set database. Here, a mapping relationship between a keyword and a web page may be implemented using existing technologies. Specifically, existing matching techniques for a web page and a keyword are used to implement a search for initial web pages based on a query term at this current block.

Here, the web pages and respective at least one product identifier referenced in the web pages that are stored in the preset database are a key to solve the technical problem addressed by the present disclosure. Here, an identifier of a product (pid) is a unique numerical ID that corresponds to the product.

At 202, the method performs relevancy processing for the initial web pages to obtain relevant web pages that satisfy a predetermined criterion.

At this block, relevancy processing is needed to be performed for the initial web pages obtained from the pre-set database. Here, in order to find relevant web pages that satisfy the needs of the user, two processes of relevancy scoring may be performed. For instance, BM25 algorithm may first be used for the initial web pages as the first relevancy scoring, and the initial web pages are ordered in a descending order of respective scores. The purposes of the first relevancy scoring are to reduce the amount of system operation for the second relevancy scoring, and to select fewer and more relevant (to the query term) web pages for the second relevancy scoring.

Prior to undergoing the second relevancy scoring, in order to reduce the amount of system operation for the second relevancy scoring, the second relevancy scoring may be performed for a number of top-ranked initial web pages that are obtained from the ordered initial web pages. Here, depending on the practical needs, the number of initial web pages to be obtained may be different, such as 1000 or 800, etc. Upon obtaining a number of top-ranked initial web pages, the second relevancy scoring may be performed for these initial web pages that have relatively higher first level relevancy scores. An approach that has more complex and refined logic may be used to obtain relevant web pages. By way of example and not limitation, scoring rules may include rendering a keyword as useless information, and subtracting a score of a web page in which this keyword is located by a predetermined value if this keyword repeatedly and continuously appears.

Additionally or alternatively, the scoring rules may include filtering a degree of matching between a category of a keyword and a category of a product identifier related to a web page, subtracting a score of a web page in which the keyword are located by a predetermined value if, for example, a brand mentioned in the keyword does not match with a brand of a product identifier that is related to the web page. Additionally or alternatively, the scoring rules may include subtracting a score of a web page in which a keyword is located by a predetermined value if a model number mentioned in the keyword does not match with a model number of a product identifier that is related to the web page.

At 203, the method performs relevancy processing for at least one product corresponding to respective product identifiers referenced in the relevant web pages.

As multiple relevant web pages may exist, product identifiers referenced in each relevant web page need to be scored. Specifically, because products referenced in different relevant web pages may be the same, web pages that have the highest-weighted product identifiers being the same are gathered together when executing this block. Specifically, products identifiers that have the highest weights in respective relevant web pages are compared, and relevant web pages having the same product identifier are gathered together into one group, which becomes a web page group for that product identifier. That group includes multiple different relevant web pages having the same product identifier.

Upon obtaining various web page groups, relevant web pages within each of these groups of product identifiers are scored. During the scoring process, a product identifier may be scored based on factors such as the number of web pages gathered under that product identifier, second relevancy scores of respective web pages, certain attributes (such as price and launching time, etc.) of that product identifier, and relevancy between the product and the query term. When executing the current block, implementation details of this process may include, for example, summing the obtained second relevancy scores together, selecting a number of products having high relevancy scores from a result thereof, arranging web pages according to prices of these products, and scoring the referenced product identifiers according to an order of the arrangement.

At this block, as a web page group gathers multiple web pages, product identifier scores associated with various web pages in that web page group are the same. These product identifier scores may be rendered as attributes of respective relevant web pages and stored in respective relevant web pages.

At 204, the method displays at least one product that has undergone the relevancy processing to the client according to respective relevancy scores.

Upon scoring the product identifiers, products referenced in each web page may be arranged in a descending order of respective product identifier scores. Information of a certain number of top ranked products may be displayed to the client. As such, the displayed information of a product is related to whether information related to that product is referenced in the web page. This therefore avoids scenarios where certain online sellers use online advertising to relate certain keywords to respective products and avoids scenarios where no relevant result is found because of the descriptive nature of a query term inputted by a user. This exemplary embodiment takes into account web page information of products during a process of displaying the products, and therefore improves user search efficiency with respect to a condition that no product is found when a query term inputted by the user does not include a specific name or attribute of a product while the web page information of the product possesses related information of the keyword. The present exemplary embodiment does not require the user to repeatedly search for relevant products, and hence reduces number of interactions between the user and a search engine server and the number of redundant operations of the search engine server, thus improving operation speed, work efficiency and work performance of the search engine server.

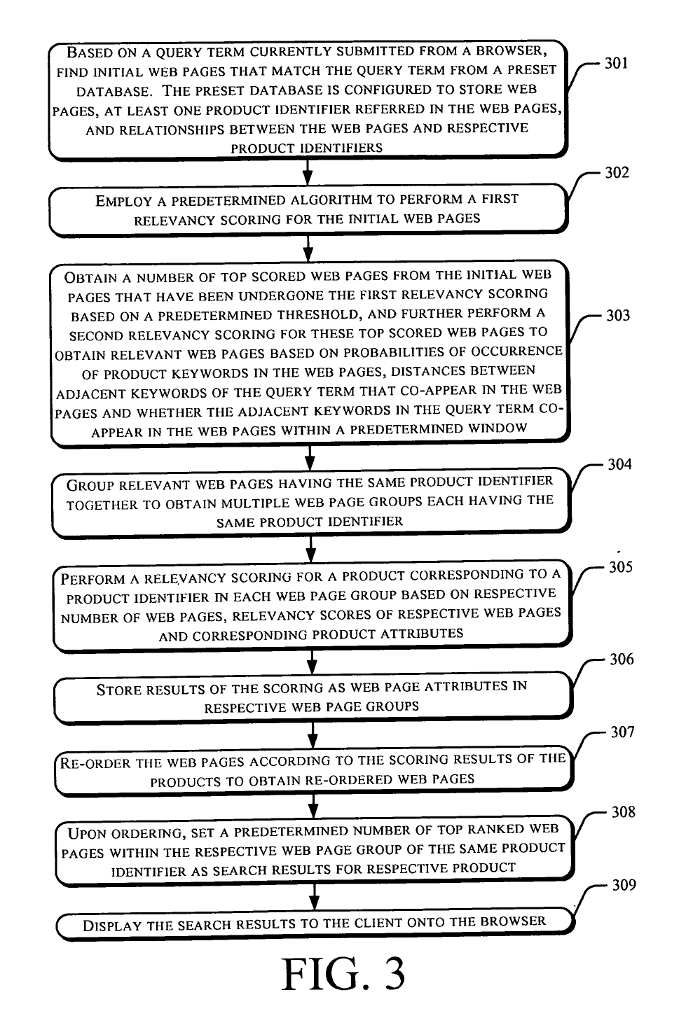

FIG. 3 shows a flowchart of a search method for an online trading platform in accordance with the second exemplary embodiment of the present disclosure.

At 301, based on a query term currently submitted from a browser, the method finds initial web pages that match the query term from a preset database. The preset database is configured to store web pages, at least one product identifier referenced in the web pages, and relationships between the web pages and respective product identifiers.

In this exemplary embodiment, existing tools, such as word parsers, part-of-speech tagging tools, etc., may be used for retrieving keywords from the query term submitted from the browser in order to reduce the cost of implementing this embodiment.

This block has been described in detail in foregoing embodiments and therefore is not redundantly described herein. In the process of setting up the preset database, a number of web pages have discussions of “mobile phones suitable for women”, and a corresponding relationship may be established between a web page and a certain product identifier (e.g., “Philips 588”). Web pages in which “mobile phones suitable for women” appears, and relationships between the web pages and specific products such as “Philips 588” are stored in the database. As such, for a query term of “mobile phones suitable for women”, various web pages that have discussions of such keyword may be found upon receiving the query term submitted from the browser.

At 302, the method employs a predetermined algorithm to perform a first relevancy scoring for the initial web pages. A score of the first relevancy scoring is proportional to a first parameter of a specified product keyword in an initial web page but inversely proportional to a second parameter thereof. The first parameter corresponds to a probability of occurrence in the present initial web page. The second parameter corresponds to a probability of occurrence among all the web pages in a web page database.

At this block, a number of relevancy algorithms in existing technologies such as BM25 may be used. This block employs any one of the relevancy algorithms in existing technologies to perform relevancy scoring for all the initial web pages. As such, each initial web page has a corresponding relevancy score. Ordering may then be performed for the initial web pages in a descending order of respective relevancy scores.

Use BM25 as an example. Upon processing the web pages according to the BM25 algorithm, a score obtained by each web page is related to two parameters. The first parameter is a probability of occurrence of a specified product keyword in a web page. The second parameter is a probability of occurrence in all the web pages in the web page database. The greater the probability associated with the first parameter is, the higher the first relevancy score of corresponding web page will be. Moreover, the first relevancy score of the corresponding web page is higher as the probability associated with the second parameter is lower. For example, as a keyword “of” is a modal particle, corresponding probability of occurrence in a web page is very high. However, since its probability of occurrence in all web pages is also high, i.e., a relatively large number of web pages having its probability of occurrence being relatively high, corresponding first relevancy score is comparatively low. In this exemplary embodiment, specified ratios of the value of a first relevancy score separately with respect to the first parameter and the second parameter may be modified based on the needs of a practical application.

At 303, the method obtains a number of top scored web pages from the initial web pages that have undergone the first relevancy scoring based on a predetermined threshold, and further performs a second relevancy scoring for these top scored web pages to obtain relevant web pages based on probabilities of occurrence of product keywords in the web pages, distances between adjacent keywords of the query term that co-appear in the web pages and whether the adjacent keywords in the query term co-appear in the web pages within a predetermined window.

At this block, upon ordering the initial web pages, a number of top ranked web pages may be obtained based on a predetermined threshold. For example, only first one thousand initial web pages are obtained. Relevancy scores of these one thousand initial web pages are higher than those of the rest of the initial web pages. Here, a second relevancy scoring is needed to be performed for these obtained web pages in order to obtain second relevancy scores of these one thousand initial web pages.

At this block, if a query term is “where to go during National Day holiday”, adjacent keywords of this query term may be “National Day” and “holiday”. Therefore, if “National Day” and “holiday” appears in a web page in a form of “National Day holiday”, the distance between these adjacent keywords of the query term appearing in the web page is nearest. As such, the score of the second relevancy scoring of this web page is relatively high. Moreover, if “National Day” and “holiday” appear simultaneously but in a form of “holiday of National Day” and if a predetermined window in that web page is twenty in size, adjacent keywords in the query term are considered as co-appearance in the predetermined window of the web page as long as a size of “holiday of National Day” is less than twenty. Correspondingly, the score of the second relevancy scoring for that web page is also relatively high.

It should be noted that various situations may exist in practical applications. Therefore, one skilled in the art may add setting of other parameters other than these three parameters according to various needs. This does not affect implementation of this disclosure.

At 304, the method groups relevant web pages having the same product identifier together to obtain multiple web page groups each having the same product identifier.

For the resulting one thousand initial web pages that have been obtained, product identifiers referenced in various initial web pages may be compared. For an initial web page that only one product identifier is referenced, only that product identifier needs to be compared. For an initial web page that multiple product identifiers are referenced, a product identifier having the highest weight may be selected for comparison based on the numbers of occurrence and position information of occurrence of the product identifiers. At the end, web pages having the same product identifier are grouped together into a web page group to produce multiple web pages each having the same product identifier.

At 305, the method performs a relevancy scoring for a product corresponding to a product identifier in each web page group based on respective number of web pages, relevancy scores of respective web pages and corresponding product attributes.

At this block, relevancy scoring needs to be performed for a product referenced in each web page group having the same product identifier. Here, when performing the relevancy processing, a product referenced in each web page group may be scored based on the number of web pages in respective web page group, the second relevancy scores of the web pages in respective web page group, attributes (e.g., price information, sales volume information, etc.) of the product itself, and a relevancy score between the product and the query term inputted by the user. It should be noted that respective weights of these factors described herein may not be completely the same during the process of relevancy scoring in practical application scenarios because of the possible differences in circumstances such as user needs or network operations, etc.

The foregoing blocks correspond to finding all “mobile phone suitable for women” by obtaining the products referenced in the web pages.

At 306, the method stores results of the scoring as web page attributes in respective web page groups.

At this block, scores of the products upon performing the relevancy scoring at block 305 may be stored as web page attributes of respective web page groups. Understandably, storing may alternatively not be performed in practical applications. Whether to store a relevancy score of a product referenced in a web page does not affect the present exemplary embodiment. This block is not an essential process of implementing this exemplary embodiment.

At 307, the method re-orders the web pages according to the scoring results of the products to obtain re-ordered web pages.

Upon performing the relevancy scoring for the products at block 305, web pages within each web page group are re-ordered in a descending order of respective scoring results.

At 308, upon ordering, the method sets a predetermined number of top ranked web pages within the respective web page group of the same product identifier as search results for respective product.

For a web page group having the same product identifier, upon ordering, a predetermined number of top ranked web pages may be set as the search results of the product. If a user searches a related keyword, relevant web pages may subsequently be found using the keyword. Corresponding products may be found based on relationships between the relevant web pages and respective products.

At 309, the method displays the search results to the client onto the browser.

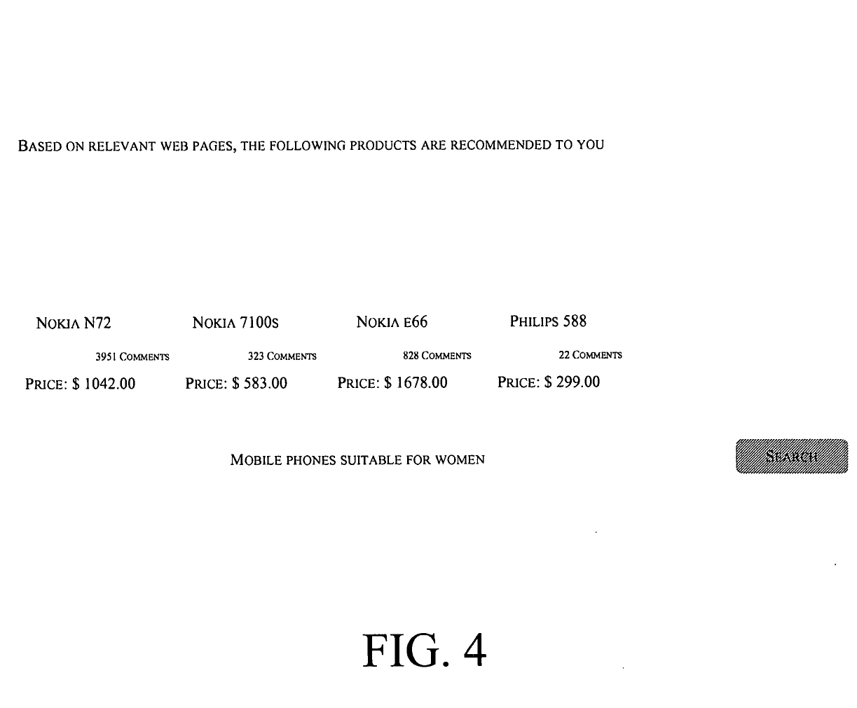

At this block, corresponding information of the products found are displayed to the client. In a practical application, for example, if the keyword is “mobile phone suitable for women”, products in the search results may be displayed as shown in FIG. 4.

For the sake of description, various embodiments described above have been presented as a series of actions. One skilled in the art should appreciate that the present disclosure is not construed by the order of actions described above. Based on the present disclosure, certain blocks may be performed in a different order or in parallel. Further, one skilled in the art should appreciate that the exemplary embodiments described herein are merely illustrative embodiments. Actions and modules involved therein may not be essential for the present disclosure.

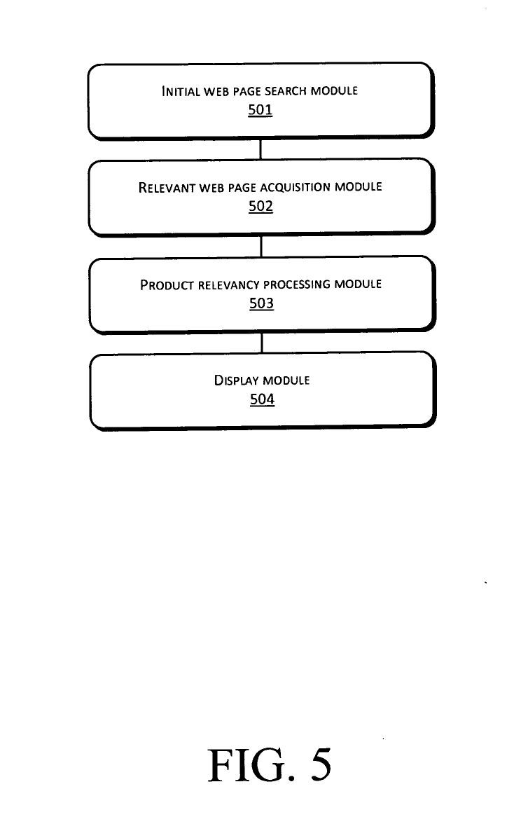

Counterpart to the first exemplary search method for an online trading platform, the present disclosure further provides a search apparatus for an online trading platform in accordance to the third exemplary embodiment as shown in FIG. 5. The apparatus may include an initial web page search module 501. Based on a query term currently submitted from a browser, the initial web page search module 501 is configured to obtain initial web pages that match the query term from a predetermined database. The predetermined database stores web pages, at least one product identifier included in the web pages, and relationships between the web pages and respective product identifiers. In one embodiment, the search apparatus may further include a relevant web page acquisition module 502, which is configured to perform relevancy processing for the initial web pages to obtain relevant web pages that satisfy predetermined criterion. Additionally, the search apparatus may include a product relevancy processing module 503. The product relevancy processing module 503 performs relevancy processing for at least one product corresponding to product identifier(s) referenced in the relevant web pages. In some embodiments, the search apparatus may further include a display module 504 that is configured to display the at least one product that has undergone the relevancy processing to a client according to respective relevancy scores.

The present exemplary apparatus may be integrated in a search engine server for the online trading platform, or separate as an individual entity that communicates with the search engine server. Furthermore, it is noted that, when implemented in software, the disclosed method may be rendered as a new function to a server of a search engine, or an individual written program. The present disclosure does not have any limitations on implementations of the disclosed method or apparatus.

In this exemplary embodiment, when searching a product based on a query term inputted by a user, a situation when that product has appeared in a web page, e.g., products related to the query term specifically discussed on Baidu website, etc., may be taken into consideration. As such, when searching for products, related products may be found based on relationships between the products and the web page. Therefore, even though a user inputs a query term that is descriptive in nature, products satisfying corresponding description may be found, thus improving user search efficiency. Using the present embodiment for product search, products desired by users can be found under normal conditions. Further, the users do not need to repeatedly search for related products, thus reducing the number of interactions between the users and a search engine server. This lowers the number of redundant operations in the search engine server, and therefore improves operation speed, work efficiency and work performance of the search engine server.

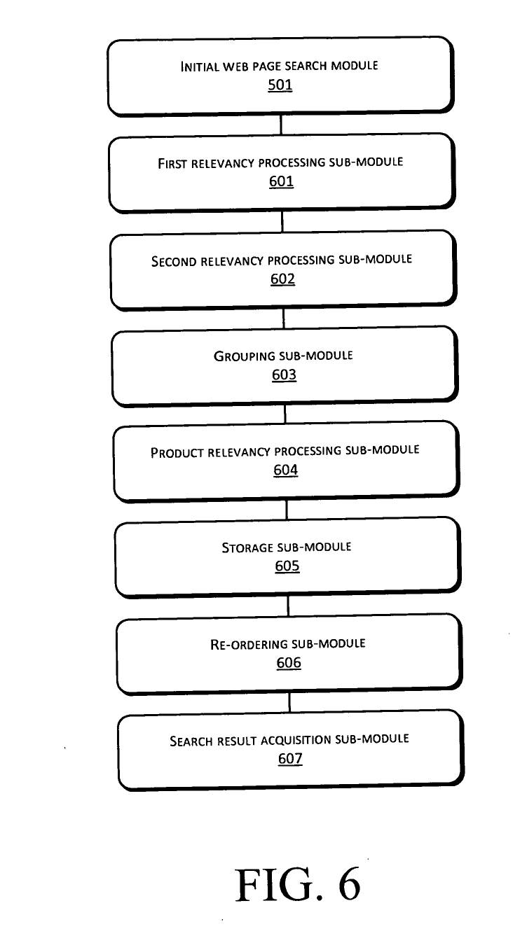

Counterpart to the second exemplary search method for an online trading platform, the present disclosure further provides a search apparatus for an online trading platform in accordance to the fourth exemplary embodiment as shown in FIG. 6. The apparatus may include an initial web page search module 501. Based on a query term currently submitted from a browser, the initial web page search module 501 may obtain initial web pages that match the query term from a predetermined database which is configured to store web pages, at least one product identifier included in the web pages, and relationships between the web pages and respective product identifiers. Additionally, the search apparatus may include a first relevancy processing sub-module 601. The first relevancy processing sub-module 601 performs a first relevancy scoring for the initial web pages using a predetermined algorithm. In one embodiment, a score of the first relevancy scoring may be proportional to a first parameter associated with a specified product keyword in an initial web page. Additionally or alternatively, the score of the first relevancy scoring may be, for example, inversely proportional to a second parameter associated with the product keyword in the initial web page. In one embodiment, the first parameter corresponds to a probability of occurrence in the web page. The second parameter may correspond to a probability of occurrence in all web pages in a web page database.

In some embodiments, the search apparatus may further include a second relevancy processing sub-module 602. The second relevancy processing sub-module 602 may obtain a number of top ranked web pages having relatively higher scores from the initial web pages that have undergone the first relevancy scoring based on a predetermined threshold. Additionally, the second relevancy processing sub-module 602 may perform a second relevancy scoring for the number of top ranked web pages to obtain relevant web pages based on one or more factors. The one or more factors may include, but are not limited to, probabilities of occurrence of product keywords in the web pages, distances between adjacent keywords of the query term that co-appear in the web pages and whether the adjacent keywords in the query term co-appear in the web pages within a predetermined window.

Furthermore, the search apparatus may include a grouping sub-module 603. The grouping sub-module 603 may be configured to group relevant web pages having the same product identifier together to obtain multiple web page groups each having the same product identifier. Additionally or alternatively, the search apparatus may further include a product relevancy processing sub-module 604 that is configured to perform a relevancy scoring for a product corresponding to a product identifier in each web page group. The product relevancy processing sub-module 604 may perform the relevancy scoring for the product based on, for example, respective number of web pages, relevancy scores of respective web pages and corresponding product attributes.

In one embodiment, the search apparatus further includes a storage sub-module 605. The storage sub-module 605 stores results of the scoring as web page attributes in respective web page groups. Additionally or alternatively, the search apparatus may include a re-ordering sub-module 606 configured to re-order the web pages according to the scoring results of the products to obtain re-ordered web pages. Additionally or alternatively, the search apparatus may include a search result acquisition sub-module 607 which, upon ordering, set a predetermined number of top ranked web pages within the respective web page group of the same product identifier as search results for respective product.

Corresponding to the search methods and the search apparatuses for the online trading platform described above, the present disclosure further provides an exemplary search engine server for the online trading platform. In this exemplary embodiment, the server may specifically include: any one of the apparatuses disclosed in the above exemplary apparatuses.

It is noted that various exemplary embodiments are progressively described in this disclosure. The main points of each exemplary embodiment may be different from other exemplary embodiments, and same or similar portions of the exemplary embodiments may be referenced with one another. The descriptions of exemplary apparatuses are relatively simple as these exemplary apparatuses are similar to their counterpart embodiments of exemplary methods. Related details can be found in the embodiments of exemplary methods.

Finally, it should be pointed out that any relational terms such as “first” and “second” in this document are only meant to distinguish one entity from another entity or one operation from another operation, but not necessarily request or imply existence of any real-world relationship or ordering between these entities or operations. Moreover, it is intended that terms such as “include”, “have” or any other variants cover non-exclusively “comprising”. Therefore, processes, methods, articles or devices which individually include a collection of features may not only be including those features, but may also include other features that are not listed, or any inherent features of these processes, methods, articles or devices. Without any further limitation, a feature defined within the phrase “include a . . . ” does not exclude the possibility that process, method, article or device that recites the feature may have other equivalent features.

The disclosed method, apparatus and server can be described in the general context of computer-executable instructions, e.g., program modules. Generally, the program modules can include routines, programs, objects, components, data structures, and the like that perform particular functions or implement particular abstract data types. The disclosed method, apparatus and server can also be practiced in a distributed computing environment where functions are performed by remote processing devices that are linked through a communication network. In a distributed computing environment, the program modules may be located in local and/or remote computer storage media, including memory storage devices.

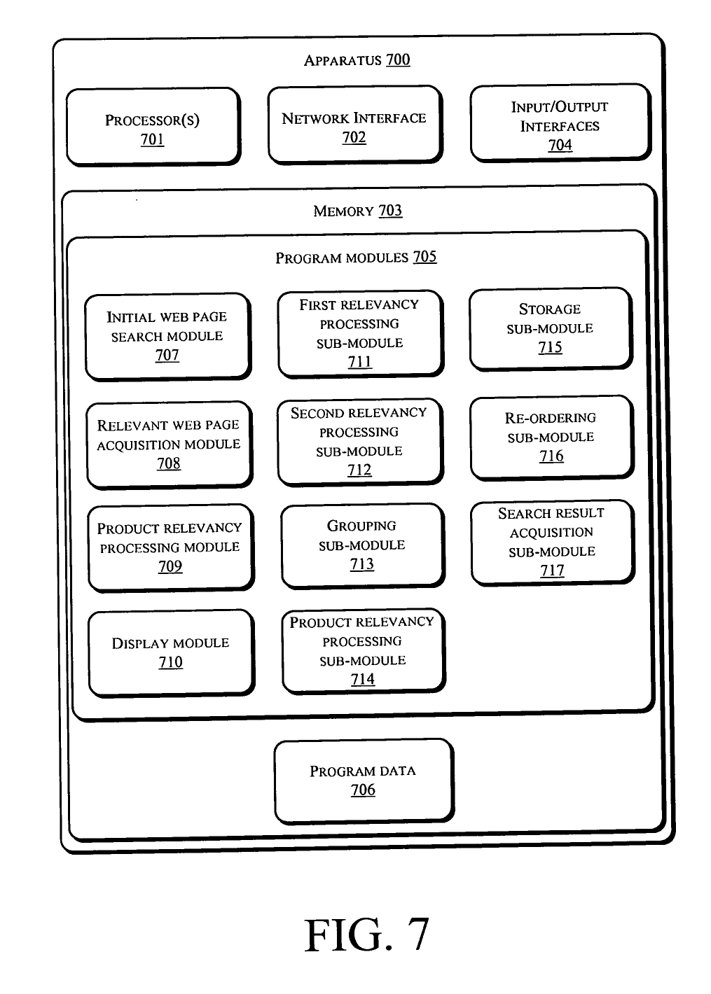

For example, FIG. 7 illustrates an exemplary apparatus 700, such as the apparatus as described above, in more detail. In one embodiment, the apparatus 700 can include, but is not limited to, one or more processors 701, a network interface 702, memory 703, and an input/output interface 704.

The memory 703 may include computer-readable media in the form of volatile memory, such as random-access memory (RAM) and/or non-volatile memory, such as read only memory (ROM) or flash RAM. The memory 703 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 703 may include program modules 705 and program data 706. In one embodiment, the program units 705 may include an initial web page search module 707, a relevant web page acquisition module 708, a product relevancy processing module 709, and a display module 710. Additionally or alternatively, in some embodiments, the program modules 705 may further include a first relevancy processing sub-module 711, a second relevancy processing sub-module 712, a grouping sub-module 713, a product relevancy processing sub-module 714, a storage sub-module 715, a re-ordering sub-module 716 and a search result acquisition sub-module 717. Details about these program modules may be found in the foregoing embodiments described above.

The search methods, apparatuses and search engine servers for an online trading platform have been described in the present disclosure in detail. Exemplary embodiments are employed to illustrate the concept and implementation of the present invention in this disclosure. The exemplary embodiments are only used for better understanding of the method and the core concepts of the present invention. Based on the concepts in this disclosure, a technical person of ordinary skills in the art may modify the exemplary embodiments and application fields. All in all, contents in the present disclosure should not be construed as limitations to the disclosed methods, apparatuses and servers.

1. A method of setting up a web page database, comprising:
fetching a web page;
analyzing keywords of the web page to obtain product keywords referenced in the web page;
analyzing the product keywords based on a predetermined rule to obtain at least one product identifier related to the web page; and
storing the web page, the at least one product identifier and a relationship between the web page and the at least one product identifier in a predetermined database.

2. The method as recited in claim 1, wherein analyzing the keywords of the web page to obtain the product keywords referenced in the web page comprises:
extracting textual content of the web page;
analyzing the textual content to obtain relevant keywords of the web page; and
obtaining the product keywords related to a product from the relevant keywords.

3. The method as recited in claim 1, wherein analyzing the product keyword based on the predetermined rule comprises:
determining candidate keywords having probabilities of occurrence that are greater than a given threshold from the product keywords; and
determining whether the candidate keywords are related to the textual content of the web page.

4. The method as recited in claim 1, further comprising storing a weight associated with the relationship between the web page and the at least one product identifier in the predetermined database.

5. The method as recited in claim 4, wherein the weight is determined based on a number of occurrences and one or more positions of occurrences of a product associated with the at least one product identifier in the web page.

6. The method as recited in claim 1, further storing information of a product associated with the at least one product identifier in the predetermined database.

7. A search method for an online trading platform, comprising:
based on a query term presently submitted from a browser, obtaining initial web pages that match the query term from a predetermined web page database, the predetermined web page database configured to store web pages, at least one product identifier referenced in a respective web page, and relationships between the product identifiers and the respective web pages;
performing relevancy processing for the initial web pages to obtain relevant web pages that satisfy a predetermined criterion;
performing relevancy processing for at least one product corresponding to a product identifier referenced in the relevant web pages; and
displaying the at least one product that has undergone the relevancy processing to a client according to respective relevancy scores.

8. The search method as recited in claim 7, wherein performing the relevancy processing for the initial web pages to obtain the relevant web pages that satisfy the predetermined criterion comprises:
performing a first relevancy scoring for the initial web pages using a predetermined algorithm, a score of the first relevancy scoring being proportional to a first parameter and inversely proportional to a second parameter associated with a specified product keyword in an initial web page, the first parameter being a probability of occurrence in the web page and the second parameter being a probability of occurrence in all web pages in the web page database.

9. The search method as recited in claim 8, wherein performing the relevancy processing for the initial web pages to obtain the relevant web pages that satisfy the predetermined criterion further comprises:
obtaining a number of top ranked web pages having relatively higher scores from the initial web pages that have undergone the first relevancy scoring based on a predetermined threshold; and
performing a second relevancy scoring for the number of top ranked web pages to obtain the relevant web pages.

10. The search method as recited in claim 9, wherein performing the second relevancy scoring for the number of top ranked web pages is based on probabilities of occurrence of product keywords in the web pages, distances between adjacent keywords of the query term that co-appear in the web pages and whether the adjacent keywords in the query term co-appear in the web pages within a predetermined window.

11. The search method as recited in claim 7, wherein performing the relevancy processing for the at least one product corresponding to the product identifier referenced in the relevant web pages comprises:
grouping relevant web pages having the same product identifier together to obtain multiple web page groups each having a same product identifier.

12. The search method as recited in claim 11, wherein performing the relevancy processing for the at least one product corresponding to the product identifier referenced in the relevant web pages further comprises:
performing a relevancy scoring for a product corresponding to a product identifier in each web page group based on respective number of web pages, relevancy scores of respective web pages and corresponding product attributes.

13. The search method as recited in claim 12, wherein performing the relevancy processing for the at least one product corresponding to the product identifier referenced in the relevant web pages further comprises:
storing results of the scoring as web page attributes in respective web page groups.

14. The search method as recited in claim 13, wherein displaying the at least one product that has undergone the relevancy processing according to respective relevancy scores comprises:
re-ordering the web pages according to the scoring results of the products to obtain re-ordered web pages; and
upon re-ordering, setting a predetermined number of top ranked web pages within the respective web page group of the same product identifier as search results for the respective product.

15. A search apparatus for an online trading platform, comprising:
an initial web page search module configured to, based on a query term, obtain initial web pages that match the query term from a predetermined database, the predetermined database configured to store web pages, at least one product identifier included in the web pages, and relationships between the web pages and respective product identifiers;
a relevant web page acquisition module configured to perform relevancy processing for the initial web pages to obtain relevant web pages that satisfy a predetermined criterion;
a product relevancy processing module, configured to perform relevancy processing for at least one product corresponding to product identifier(s) referenced in the relevant web pages; and
a display ordering module configured to display the at least one product that has undergone the relevancy processing to a client according to respective relevancy scores.

16. The search apparatus as recited in claim 15, wherein the relevant web page acquisition module comprises:
a first relevancy processing sub-module configured to perform a first relevancy scoring for the initial web pages using a predetermined algorithm, a score of the first relevancy scoring being proportional to a first parameter and inversely proportional to a second parameter associated with a specified product keyword in an initial web page, the first parameter being a probability of occurrence in the web page and the second parameter being a probability of occurrence in all web pages in the web page database.

17. The search apparatus as recited in claim 16, wherein the relevant web page acquisition module further comprises:
a second relevancy processing sub-module configured to obtain a number of top ranked web pages having relatively higher scores from the initial web pages that have undergone the first relevancy scoring based on a predetermined threshold, and perform a second relevancy scoring for the number of top ranked web pages to obtain relevant web pages based on probabilities of occurrence of product keywords in the web pages, distances between adjacent keywords of the query term that co-appear in the web pages and whether the adjacent keywords in the query term co-appear in the web pages within a predetermined window.

18. The search apparatus as recited in claim 15, wherein the product relevancy processing module comprises:
a grouping sub-module configured to group relevant web pages having the same product identifier together to obtain multiple web page groups each having the same product identifier.

19. The search apparatus as recited in claim 18, wherein the product relevancy processing module further comprises:
a product relevancy processing sub-module configured to perform a relevancy scoring for a product corresponding to a product identifier in each web page group based on respective number of web pages, relevancy scores of respective web pages and corresponding product attributes.

20. The search apparatus as recited in claim 19, wherein the product relevancy processing module further comprises:
a storage sub-module configured to store results of the scoring as web page attributes in respective web page groups.
